(19) United States
(12) Patent Application Publication
(10) Pub. No.: US 2026/0329622 A1
(43) Pub. Date: Oct. 22, 2026

(54) SCHEDULING OF INTERRUPT HANDLING

(71) Applicant: Intel Products IP LLC, Santa Clara, CA (US)

(72) Inventors: Nishant TAMRAKAR, Jabalpur (IN); Piyush PANDEY, Bangalore (IN); Shreyas KUNDER, Bangalore (IN); Umera BANU, Bengaluru (IN); Prem Nath DEY, Bangalore (IN)

(21) Appl. No.: 19/694,368

(22) Filed: Jun. 1, 2026

(51) Int. Cl. G06F 9/48

(52) U.S. Cl. CPC G06F 9/4812; G06F 9/4856; G06F 9/4881

(57) ABSTRACT

Examples described herein relate to a network interface controller that includes a host interface; a network interface; and circuitry. In some examples, the circuitry is to: monitor packet processing load across multiple Non-Uniform Memory Access (NUMA) domains, wherein individual ones of the NUMA domains comprising at least one processor and having a range of latency to access memory and different ones of the multiple NUMA domains have different ranges of latency; and predictively migrate interrupt request handling from one of the multiple NUMA domains to another of the multiple NUMA domains.

### BACKGROUND

A Non-Uniform Memory Access (NUMA) domain is a grouping of processors, cores, and memory within a multiprocessor system that allows specific processor cores to access memory at approximately uniform rates. However, accessing data from another NUMA domain can increase a time taken to access the data.

### BRIEF DESCRIPTION OF THE DRAWINGS

FIG. 1 depicts an example system.

FIG. 2A shows an example system.

FIG. 2B depicts an example of states.

FIG. 3 depicts an example process.

FIGS. 4A and 4B depict example network interface devices.

FIG. 5 depicts an example network interface device.

FIG. 6 depicts an example system.

### DETAILED DESCRIPTION

A NUMA node can be associated with a network interface device and packets received by the network interface device can be stored in a memory of the NUMA node. To reduce memory access latency arising from reading packets received by the network interface device, packets can be processed on processors of the NUMA node of the network interface device. A NUMA node can become overloaded by processing packets. Processor saturation can lead to increased interrupt handling latency, packet drops, and tail latency spikes. Various examples can prioritize performing interrupt handling in a NUMA domain with a memory that stores the received packet. Various examples can forecast an increase in latency of processing interrupts indicative of packet receipt and can perform predictive load-balancing of interrupts among NUMA nodes by monitoring at least packet processing backlog, ingress packet queue depth, timestamp intervals between interrupts or received packets, or per-core utilization. Based on this prediction, various examples can proactively migrate interrupt handling to a lower utilized NUMA domain. Various examples can provide approximately uniform interrupt handling performance under bursty traffic conditions by forecasting processor saturation and adjusting interrupt handling dynamically among one or more NUMA nodes. NUMA domains can include a processor and have a range of latency to access memory. Different NUMA domains can have different ranges of latency to access memory.

A prediction engine can monitor traffic metrics and forecast NUMA node saturation using machine learning (ML) models. Interrupt handling of received packets can be scheduled on cores of a NUMA domain of the network interface device that received the packets but interrupt handling can be proactively shifted to cores of a different NUMA node if overload of the NUMA domain is predicted. Interrupt handling and application threads can be performed in the same NUMA domain to reduce remote memory access latency.

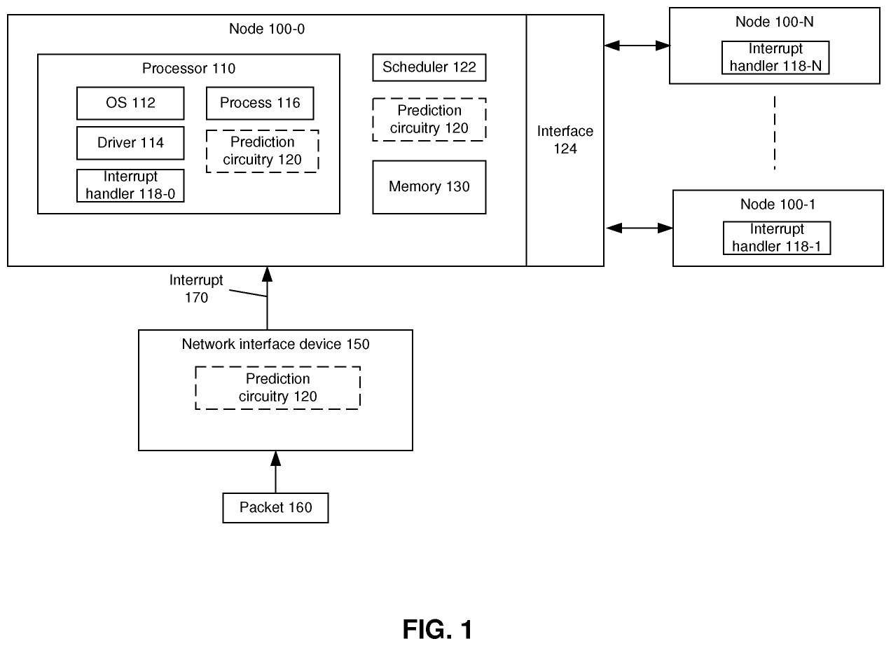

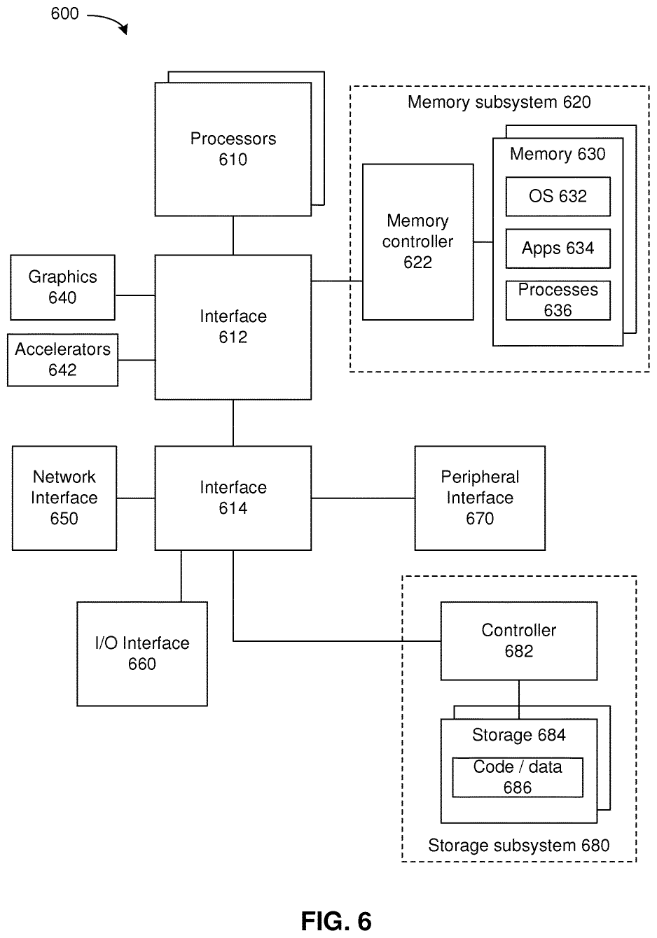

FIG. 1 depicts an example system. NUMA nodes 100-0 to 100-N, where N is an integer, can include a grouping of processors, cores, accelerators, interfaces, network interface devices, memory, or other circuitry. Various examples of circuitry in a NUMA node domain is described at least with respect to FIG. 6.

NUMA nodes 100-0 to 100-N can be communicatively coupled by interface 124. Interface 124 can include a bus or switch and can be consistent with Intel's Ultra Path Interconnect (UPI) or Advanced Micro Devices, Inc. (AMD) Infinity Fabric, among others. A NUMA domain can be implemented in a system on chip (SoC) or die. Die-to-die communications can utilize an interposer, switch, or other communication technologies. Components of examples described herein can be enclosed in one or more semiconductor packages. A semiconductor package can include metal, plastic, glass, and/or a ceramic casing that encompass and provide communications within or among one or more semiconductor devices or integrated circuits.

Network interface device 150 can receive packet 160 and can copy payload and/or header of packet 160 into memory 130 of domain 100-0. Network interface device 150 can include forwarding element, network interface device, or other devices. In some examples, a network interface device can refer to one or more of: a network interface controller (NIC), a remote direct memory access (RDMA)-enabled NIC, SmartNIC, router, switch, infrastructure processing unit (IPU), data processing unit (DPU), or network-attached appliance.

A packet may be used herein to refer to various formatted collections of bits that may be sent across a network, such as Ethernet frames, Internet Protocol (IP) packets (e.g., IPv4 or IPv6), Transmission Control Protocol (TCP) segments, User Datagram Protocol (UDP) datagrams, etc. A flow can be a sequence of packets being transferred between two endpoints, generally representing a single session using a protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique queue pair (QP) number or identifier.

A connection can include a reliable communication link between two devices on a network whereby packets are sent, received, and reassembled in-order. Examples of reliable communication links include TCP, UDP, quick UDP Internet Connections (QUIC), RDMA over Converged Ethernet (RoCE), and others.

Based on receipt of packet 160, network interface device 150 can issue interrupt 170 to NUMA node domain 100-0 to process header and/or payload of received packet 160. Interrupt 170 can include a Interrupt Request (IRQ) or Software Interrupt Requests (SoftIRQ). An IRQ can include a hardware signal sent to operating system (OS) 112, indicating receipt of packet 160 and causing halting of activities of OS 112 to process packet 160. SoftIRQ handling can perform time-sensitive tasks such as network packet processing without blocking hardware interrupts.

In other examples, interrupt 170 can be triggered by a packet transmission. After packet transmission is completed, network interface device 150 can trigger an interrupt 170 to processor 110 of NUMA domain 100-0 to signal to driver 114 that buffer memory for the packet that was transmitted can now be freed or reused.

Network interface device 150 can utilize prediction circuitry 120 to forecast interrupt handling loads and resource saturation in NUMA node 100-0 using heuristics or machine learning (ML) models. For example, prediction circuitry 120 can forecast upcoming interrupt handling load and node saturation in a NUMA node based at least on packet receipt timestamps, ingress packet queue depth, and/or interrupt handling backlog in files in kernel space. Based on prediction of load for the NUMA node from prediction circuitry 120, scheduler 122 can schedule interrupt handler 118-0 on NUMA node domain 100-0 or another domain (e.g., 100-1 or 100-N). For example, a default policy can be to schedule interrupt handling on NUMA cores that also process packets from network interface device 150 (e.g., node 100-0). A local NUMA core in node 100-0 can include a core closer to a memory channel and on same memory die and lower IRQ latency.

Based on predicted overload of a NUMA node 100-0, scheduler 122 can distribute interrupt handling to a remote NUMA core (e.g., node 100-1 or 100-2). A remote NUMA core can include a core further from a memory channel and on different memory die and die-to-die traversal may be involved and corresponding increased interrupt processing latency and packet processing latency. Scheduler 122 can migrate an interrupt handler and application thread that process packets to remote NUMA node cores to reduce remote memory access latency.

Prediction engine 120 and/or scheduler 122 can be performed by one or more of: network interface device 150, operating system (OS) 112, driver 114 for network interface device 150, or processor-executed software.

Although examples are provided with respect to a network interface device, other devices can be used instead or in addition, such as a storage controller, memory controller, fabric interface, processor, application specific integrated circuit (ASIC), and/or accelerator device.

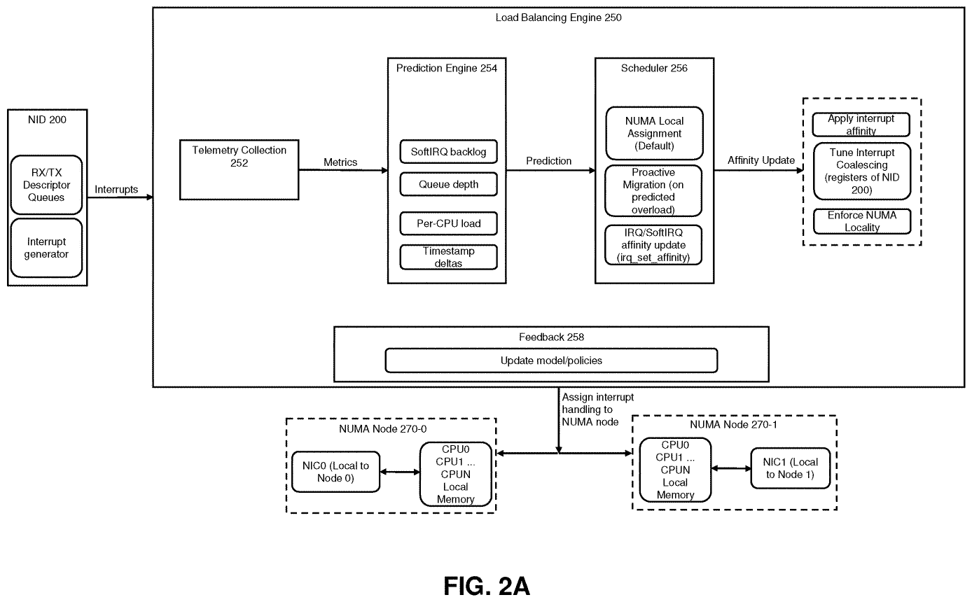

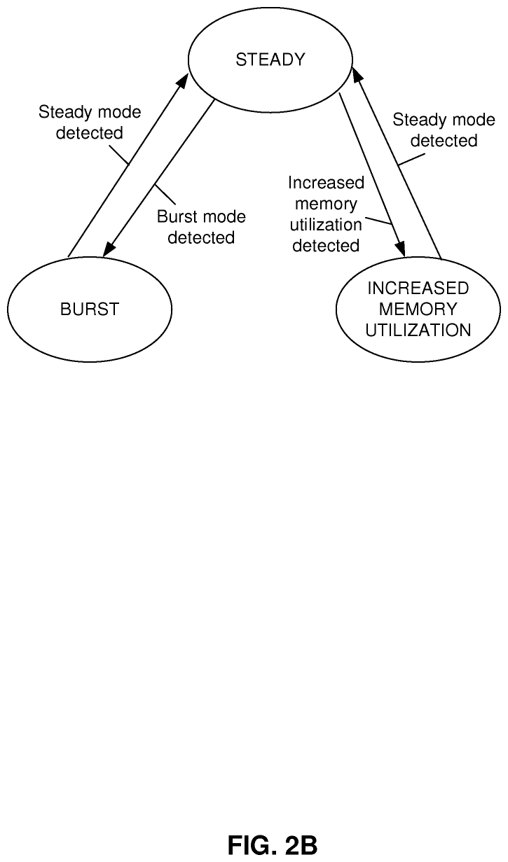

FIG. 2A depicts an example system. Network interface device (NID) 200 can receive or transmit packets based on descriptors in receive (RX)/transmit (TX) descriptor queues. At least based on receipt of a packet, NID 200 can issue an interrupt to load balancing engine 250. Load balancing engine 250 can determine a NUMA domain to process the interrupt from NID 200 based on processor load of NUMA nodes 270-0 to 270-1. The processor load can be based on interrupt handling load and/or loads from other processes and a load of the NUMA domain. In some examples, interrupts associated with received packets of a same flow or connection can be placed or migrated to a same NUMA domain. In some examples, interrupts associated with received packets of a same flow or connection can be processed by different NUMA domains.

Prediction engine 254 can utilize machine learning (ML) models to forecast increased latency from processing interrupts in a NUMA domain based at least on metrics of packets received per second, packet processing backlog, number of active connections, ingress packet queue depth, timestamp intervals between interrupts or received packets, interrupt queue depth, processor utilization, memory utilization, or other data. For example, telemetry collection 252 can measure the metrics or access the metrics from traces or other recorders of processor activity. For example, telemetry collection 252 can include network interface device 200 firmware tracking telemetry data for a NUMA node.

For example, scheduler 256 can select a same NUMA domain that stores the received packet (e.g., in memory or cache) to also perform an interrupt handler to process the interrupt. The interrupt can be processed by the same core or processor that executes a thread or process that is to process the received packet. For example, a core or processor can execute an operating system and/or driver to process the received packet. For example, the operating system and/or driver can perform one or more of: check header checksums, parse protocol types, apply local firewall rules, connection tracking, sequence reordering, generating acknowledgments, places the packet into the receive buffer queue assigned to that specific socket, alerts the application that data is waiting (e.g., waking the process up or signaling epoll or select), copy the packet's data from the kernel's memory space into the application's memory space or cache, or other operations.

An interrupt handler (e.g., Interrupt Service Routine (ISR)) for packet receipt can process incoming network data by acknowledging receipt of the packet, copying the packet from the network interface device to memory, and scheduling processing (e.g., softIRQ or threaded IRQ) to handle the packet processing.

An application can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Scheduler 256 can configure NUMA nodes (domains) 270-0 and 270-1 by dynamic affinity and coalescing to update affinity of interrupt handlers to cores. Although two domains are shown, more than two domains can be utilized. Scheduler 256 can dynamically adjust interrupt coalescing based on a phase of operation. Scheduler 256 can select one or more NUMA domains to perform interrupt handling per phase such as steady state, burst, connection spikes, read-heavy or write-heavy phases. Steady phase can indicate low variation in received packets per second (PPS) with no predicted increase in packet processing latency. Burst phase can include an increase in PPS or increase in number of connections between sender and receiver, with differences between expected and actual latency and average PPS and actual PPS, and can cause distribution of interrupt handling to a different NUMA node. Read heavy phase can include high rate of reading received packets (RX) with a difference level between expected and actual rate of reads, and can cause distribution of interrupt handling to a different NUMA node. Write heavy phase can include an increased rate of writing transmitted packets (TX) to memory with a difference level between expected and actual writes, and can cause distribution of interrupt handling to a different NUMA node. Scheduler 256 can migrate interrupt handling to a NUMA node that handles packet processing based on change of phase back to steady state.

Feedback 258 can compare predicted interrupt handling latency or rate of interrupt handling against actual interrupt handling latency or interrupt handling rate to adjust prediction models used by prediction engine 254 to reduce differences between predicted and actual interrupt handling latencies or rates that trigger changes in phase. For example, scheduler 256 can reduce the difference level(s) to trigger burst phase or read/write heavy phases by a particular rate to increase responsiveness to entering burst or read/write heavy phases from steady state phase. For example, scheduler 256 can increase the difference level(s) to trigger burst phase or read/write heavy phases by a particular rate if the triggers to entering burst or read/write heavy phases from steady state phase do not reduce latency of interrupt handling.

Various examples of load balancing engine 250 can be implemented in one or more of: operating system, firmware, NID 200, system software, applications, or other software or circuitry.

FIG. 2B depicts an example of phases of operation. Based on telemetry metric values, phases can change from steady to burst or read/write heavy or back to steady. A steady phase of operation can utilize a NUMA node to handle interrupts for packets received or transmitted from the same NUMA node. A burst phase of operation can be associated with an increase in rate of received interrupts and can cause migration of interrupt handling and/or application threads to another NUMA node. An increased level of memory utilization (read or write) phase of operation can be associated with an increase in rate of reading or writing to a memory of a NUMA node and can cause migration of interrupt handling and/or application threads to another NUMA node. Changing from steady to burst or read/write heavy can cause assignment or migration of interrupt handling to a different NUMA node or nodes than a NUMA node that handles packet processing.

After changing to a burst or increased level of memory utilization phase of operation, the phase can return to steady phase based on detected reduced rate of received interrupts, a predicted increase in latency of processing interrupts at the current NUMA node, and/or reduced rate of reading or writing to a memory of the current NUMA node. Changing to steady from burst or read/write heavy can cause assignment or migration of interrupt handling to a same NUMA node as handles packet processing or no change in the NUMA node that performs interrupt handling and packet processing.

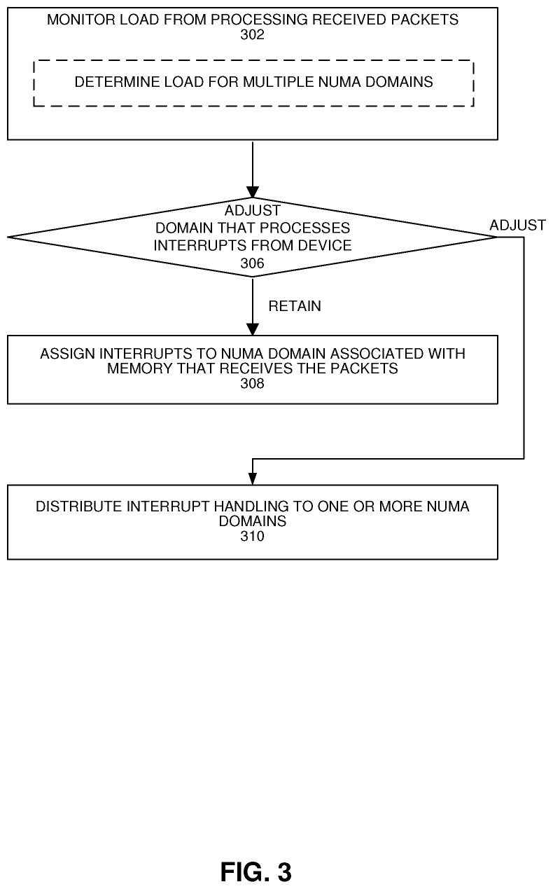

FIG. 3 depicts an example process for allocation of interrupt handlers to one or more NUMA domains based on loads of the one or more NUMA domains. At 302, a load from processing packets or other data in multiple NUMA domains can be determined. A first NUMA domain can include processors and memory to store received packets. For example, for the first NUMA domain and at least one other NUMA domain, a load on processor and/or memory resources can be determined.

At 304, a determination can be made as to whether NUMA domain overload is expected and whether to select the first NUMA domain or another NUMA domain to process interrupts for received packets or other data. For example, based on queue utilization being less than a first level, and/or a rate of interrupts being less than a second level, the first NUMA domain can be determined to be not overloaded. For example, based on queue utilization being more than a first level, and/or a rate of interrupts being more than a second level, overload of the first NUMA domain can be determined. Operation 304 can predict interrupt processing overload and proactively migrate interrupt handling to another NUMA domain before latency spikes or packet drops occur based on signals such as interrupt backlog growth, received packet queue depth, deltas between packet timestamps, per-core utilization trends, or others. Operation 304 can assign interrupt handling to one or more NUMA domains per phase or timestamp based on workload-phase by learned patterns such as steady state or burst, connection spikes, read-heavy or write-heavy phases.

At 308, based on determined non-overload of the first NUMA domain, the processing of interrupts can be assigned to the first NUMA domain. In addition, the packet processing and/or application thread can be executed in the first NUMA domain.

At 310, based on determined overload of the first NUMA domain, the processing of interrupts can be assigned to the first NUMA domain and at least one other NUMA domain or at least one other NUMA domain. In addition, the packet processing and/or application thread can be executed or migrated to the at least one other NUMA domain.

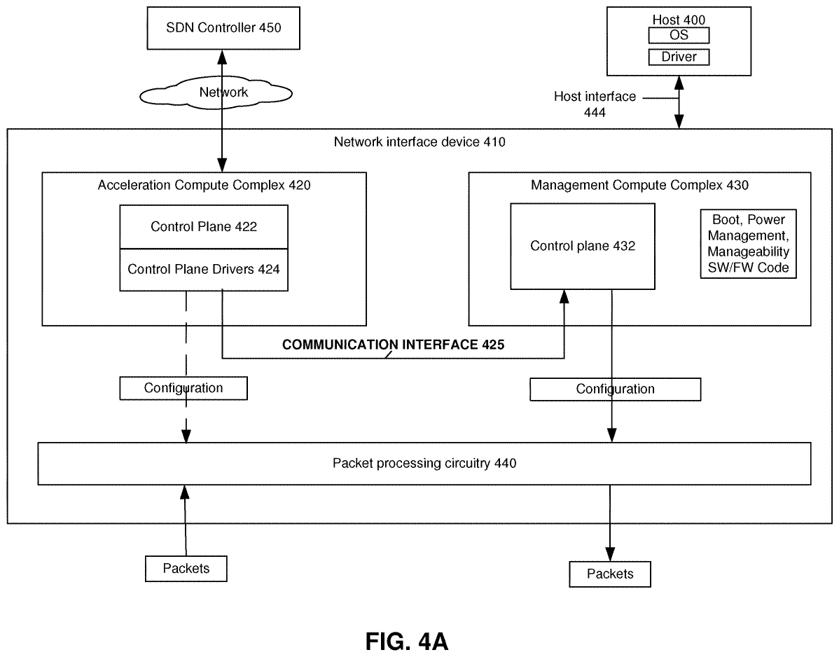

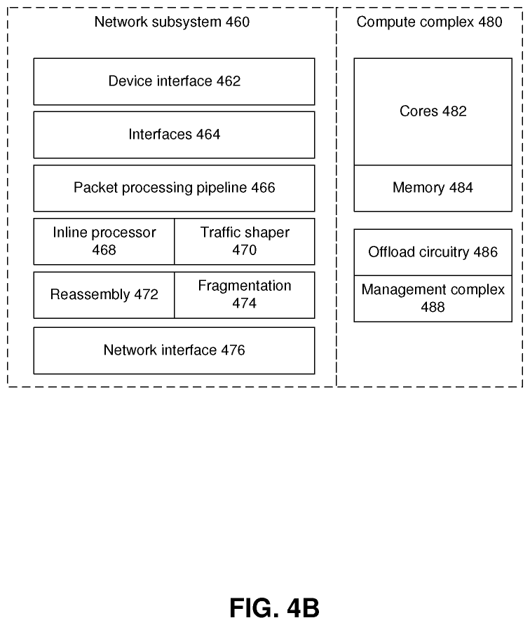

FIG. 4A depicts an example system. Host 400 can include processors, memory devices, device interfaces, as well as other circuitry described herein. Processors of host 400 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 410 to determine a NUMA node to process interrupts, as described herein. Host 400 can be coupled to network interface device 410 via a host or device interface 444.

Network interface device 410 can include multiple compute complexes, such as an Acceleration Compute Complex (ACC) 420 and Management Compute Complex (MCC) 430, as well as packet processing circuitry 440 and network interface technologies for communication with other devices via a network. ACC 420 can be implemented as one or more of: a microprocessor, processor, accelerator, field programmable gate array (FPGA), application specific integrated circuit (ASIC) or circuitry described herein. Similarly, MCC 430 can be implemented as one or more of: a microprocessor, processor, accelerator, field programmable gate array (FPGA), application specific integrated circuit (ASIC) or circuitry described herein. In some examples, ACC 420 and MCC 430 can be implemented as separate cores in a CPU, different cores in different CPUs, different processors in a same integrated circuit, different processors in different integrated circuit.

Network interface device 410 can be implemented as one or more of: a microprocessor, processor, accelerator, field programmable gate array (FPGA), application specific integrated circuit (ASIC) or circuitry described herein. Packet processing pipeline circuitry 440 can process packets as directed or configured by one or more control planes executed by multiple compute complexes. In some examples, ACC 420 and MCC 430 can execute respective control planes 422 and 432.

SDN controller 450 can upgrade or reconfigure software executing on ACC 420 (e.g., control plane 422 and/or control plane 432) through contents of packets received through packet processing device 410. In some examples, ACC 420 can execute control plane operating system (OS) (e.g., Linux) and/or a control plane application 422 (e.g., user space or kernel modules) used by SDN controller 450 to configure operation of packet processing pipeline 440. Control plane application 422 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 450 can communicate with ACC 420 using a remote procedure call (RPC) such as Google remote procedure call (gRPC) or other service and ACC 420 can convert the request to target specific protocol buffer (protobuf) request to MCC 430. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 450 can provide packet processing rules for performance by ACC 420. For example, ACC 420 can program table rules (e.g., header field match and corresponding action) applied by packet processing pipeline circuitry 440 based on change in policy and changes in VMs, containers, microservices, applications, or other processes. ACC 420 can be configured to provide network policy as flow cache rules into a table to configure operation of packet processing pipeline 440. For example, the ACC-executed control plane application 422 can configure rule tables applied by packet processing pipeline circuitry 440 with rules to define a traffic destination based on packet type and content. ACC 420 can program table rules (e.g., match-action) into memory accessible to packet processing pipeline circuitry 440 based on change in policy and changes in VMs.

For example, ACC 420 can execute a virtual switch such as vSwitch or Open vSwitch (OVS), Stratum, or Vector Packet Processing (VPP) that provides communications between virtual machines executed by host 400 or with other devices connected to a network. For example, ACC 420 can configure packet processing pipeline circuitry 440 as to which VM is to receive traffic and what kind of traffic a VM can transmit. For example, packet processing pipeline circuitry 440 can execute a virtual switch such as vSwitch or Open vSwitch that provides communications between virtual machines executed by host 400 and packet processing device 410.

MCC 430 can execute a host management control plane, global resource manager, and perform hardware registers configuration. Control plane 432 executed by MCC 430 can perform provisioning and configuration of packet processing circuitry 440. For example, a VM executing on host 400 can utilize packet processing device 410 to receive or transmit packet traffic. MCC 430 can execute boot, power, management, and manageability software (SW) or firmware (FW) code to boot and initialize the packet processing device 410, manage the device power consumption, provide connectivity to a management controller (e.g., Baseboard Management Controller (BMC)), and other operations.

One or both control planes of ACC 420 and MCC 430 can define traffic routing table content and network topology applied by packet processing circuitry 440 to select a path of a packet in a network to a next hop or to a destination network-connected device. For example, a VM executing on host 400 can utilize packet processing device 410 to receive or transmit packet traffic.

ACC 420 can execute control plane drivers to communicate with MCC 430. At least to provide a configuration and provisioning interface between control planes 422 and 432, communication interface 425 can provide control-plane-to-control plane communications. Control plane 432 can perform a gatekeeper operation for configuration of shared resources. For example, via communication interface 425, ACC control plane 422 can communicate with control plane 432 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 425 can be utilized by a negotiation protocol and configuration protocol running between ACC control plane 422 and MCC control plane 432. Communication interface 425 can include a general purpose mailbox for different operations performed by packet processing circuitry 440. Examples of operations of packet processing circuitry 440 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 425 can include one or more mailboxes accessible as registers or memory addresses. For communications from control plane 422 to control plane 432, communications can be written to the one or more mailboxes by control plane drivers 424. For communications from control plane 432 to control plane 422, communications can be written to the one or more mailboxes. Communications written to mailboxes can include descriptors which include message opcode, message error, message parameters, and other information. Communications written to mailboxes can include defined format messages that convey data.

Communication interface 425 can provide communications based on writes or reads to particular memory addresses (e.g., dynamic random access memory (DRAM)), registers, other mailbox that is written-to and read-from to pass commands and data. To provide for secure communications between control planes 422 and 432, registers and memory addresses (and memory address translations) for communications can be available only to be written to or read from by control planes 422 and 432 or cloud service provider (CSP) software executing on ACC 420 and device vendor software, embedded software, or firmware executing on MCC 430. Communication interface 425 can support communications between multiple different compute complexes such as from host 400 to MCC 430, host 400 to ACC 420, MCC 430 to ACC 420, management controller to MCC 430, management controller to ACC 420, or management controller to host 400.

Packet processing circuitry 440 can be implemented using one or more of: application specific integrated circuit (ASIC), field programmable gate array (FPGA), processors executing software, or other circuitry. Control plane 422 and/or 432 can configure packet processing pipeline circuitry 440 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

FIG. 4B depicts an example network interface device system. Various examples of packet processing device or network interface device 410 can utilize examples of circuitry and software described herein. Various examples of packet processing device or network interface device 410 can determine a NUMA node to process interrupts for received packets, as described herein. In some examples, packet processing device or network interface device can include one or more of: a network interface controller (NIC), a remote direct memory access (RDMA)-enabled NIC, SmartNIC, router, switch, forwarding element, infrastructure processing unit (IPU), or data processing unit (DPU). Network subsystem 460 can be communicatively coupled to compute complex 480. Device interface 462 can provide an interface to communicate with a host. Various examples of device interface 462 can utilize protocols based on Peripheral Component Interconnect Express (PCIe), Compute Express Link (CXL), or others as well as virtual device interface such as virtual device interfaces.

Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification version 1.0 (2019), as well as earlier versions, later versions, and variations thereof.

Interfaces 464 can initiate and terminate at least offloaded remote direct memory access (RDMA) operations, Non-volatile memory express (NVMe) reads or writes operations, and LAN operations. Packet processing pipeline 466 can perform packet processing (e.g., packet header and/or packet payload) based on a configuration and support quality of service (QoS) and telemetry reporting. Inline processor 468 can perform offloaded encryption or decryption of packet communications (e.g., Internet Protocol Security (IPSec) or others). Traffic shaper 470 can schedule transmission of communications. Network interface 476 can provide an interface at least to an Ethernet network by media access control (MAC) and serializer/de-serializer (Serdes) operations.

Cores 482 can be configured to perform infrastructure operations such as storage initiator, Transport Layer Security (TLS) proxy, virtual switch (e.g., vSwitch), or other operations. Memory 484 can store applications and data to be performed or processed. Offload circuitry 486 can perform at least cryptographic and compression operations for host or use by compute complex 480. Offload circuitry 486 can include one or more graphics processing units (GPUs) that can access memory 484. Management complex 488 can perform secure boot, life cycle management and management of network subsystem 460 and/or compute complex 480.

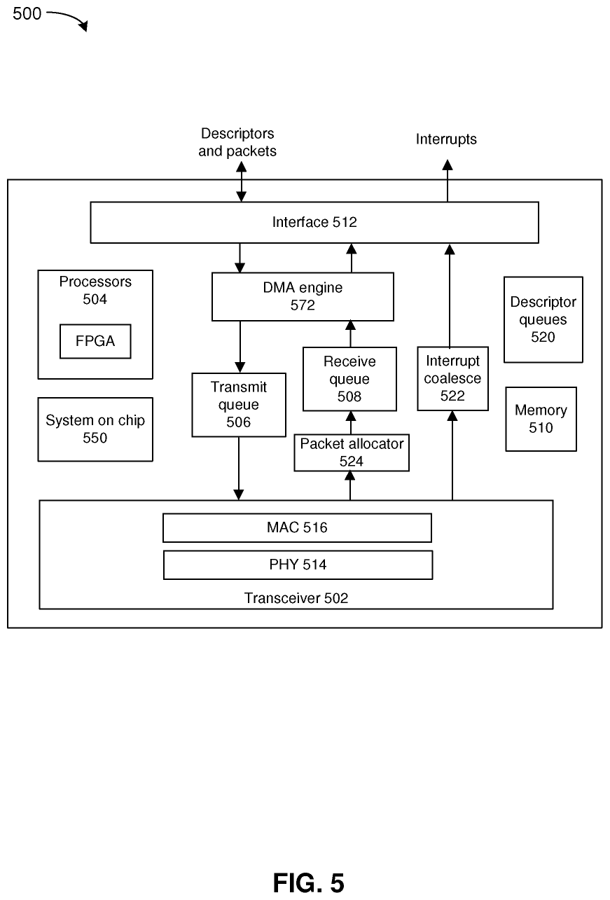

FIG. 5 depicts an example network interface device or packet processing device. Processors 504 or other circuitry can be used to determine a NUMA node to process interrupts, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or Double Data Rate (DDR). Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and host interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

System on chip (SoC) 550 and processors 504 can include any a combination of: processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 524 can provide distribution of received packets for processing by multiple CPUs or cores using timeslot allocation or receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Host interface 512 can provide an interface with host device (not depicted). For example, host interface 512 can be compatible with PCI, PCI Express, PCI-x, Serial ATA, and/or USB compatible interface (although other interconnection standards may be used). In some examples, memory 510 can be off chip from other circuitry and accessible via an interface.

FIG. 6 depicts a system. In some examples, network interface device 650 can be configured to determine a NUMA node to process interrupts, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

Configuration of network interface device 650 can be consistent with versions of Network Driver Interface Specification (NDIS), Network Adapter Class Extension (NetAdapterCx), or others. For example, network interface device 650 can advertise capabilities to determine a NUMA node to process interrupts, as described herein. OS 632 or a driver can enable or disable the capabilities by calling an application programming interface (API).

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize an interposer, switch, or silicon bridge that provides communication between dies. For example, die-to-die communications can be provided by an Embedded Multi-die Interconnect Bridge (EMIB), Chip-on-Wafer-on-Substrate (CoWoS), or other devices. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more later examples and includes a network interface controller, comprising a host interface; a network interface; and circuitry to: monitor packet processing load across multiple Non-Uniform Memory Access (NUMA) domains, wherein individual ones of the NUMA domains comprising at least one processor and having a range of latency to access memory and different ones of the multiple NUMA domains have different ranges of latency; and predictively migrate interrupt request handling from one of the multiple NUMA domains to another of the multiple NUMA domains.

Example 2 includes one or more later or earlier examples, wherein the circuitry to monitor comprises circuitry to monitor at least one of interrupt backlog, queue depth, packet receipt timestamp intervals, per-core utilization, or memory utilization.

Example 3 includes one or more later or earlier examples, wherein the circuitry is to allocate interrupt request handling in one of the multiple NUMA domains associated with the network interface controller by default.

Example 4 includes one or more later or earlier examples, wherein the circuitry is to predictively migrate interrupt request handling from one of the multiple NUMA domains to another of the multiple NUMA domains based on load of the one of the multiple NUMA domains.

Example 5 includes one or more later or earlier examples, wherein: the circuitry is to predictively migrate interrupt request handling from one of the multiple NUMA domains to another of the multiple NUMA domains based on load of the one of the multiple NUMA domains and the load is based on one or more of: interrupt queue depth, packet receipt timestamps, intervals between interrupts, core utilization, or memory utilization.

Example 6 includes one or more later or earlier examples, wherein the interrupts indicate receipt of packets by the network interface controller.

Example 7 includes one or more later or earlier examples, wherein the interrupt handling is to perform processing of interrupts triggered by receipt of packets by a network interface device.
Example 8 includes one or more later or earlier examples, comprising circuitry to assign an application thread to process packets to a NUMA domain that performs interrupt handling.
Example 9 includes one or more later or earlier examples, wherein the circuitry is to: migrate performance of interrupt handling back to the one of the multiple NUMA domains from the another of the multiple NUMA domains.

Example 10 includes one or more later or earlier examples, and includes at least one non-transitory computer-readable medium comprising instructions stored thereon, that if executed by one or more processors, cause the one or more processors to: configure a network interface device to: indicate a capability to determine a Non-Uniform Memory Access (NUMA) node to process interrupts and based on a request to perform the capability, enable the capability in the network interface device to perform: monitor packet processing load across multiple Non-Uniform Memory Access (NUMA) domains, wherein individual ones of the NUMA domains comprising at least one processor and having a range of latency to access memory and different ones of the multiple NUMA domains have different ranges of latency; and predictively migrate interrupt request handling from one of the multiple NUMA domains to another of the multiple NUMA domains.

Example 11 includes one or more later or earlier examples, wherein the packet processing load is based at least on one of: interrupt backlog, queue depth, packet receipt timestamp intervals, per-core utilization, or memory utilization.

Example 12 includes one or more later or earlier examples, wherein: based on a request to perform the capability, enable the capability in the network interface device to allocate interrupt request handling in one of the multiple NUMA domains associated with the network interface device by default.

Example 13 includes one or more later or earlier examples, wherein the network interface device is to predictively migrate interrupt request handling from one of the multiple NUMA domains to another of the multiple NUMA domains based on load of the one of the multiple NUMA domains.

Example 14 includes one or more later or earlier examples, wherein: based on a request to perform the capability: the network interface device is to predictively migrate interrupt request handling from one of the multiple NUMA domains to another of the multiple NUMA domains based on load of the one of the multiple NUMA domains and the load is based on one or more of: interrupt queue depth, packet receipt timestamps, intervals between interrupts, core utilization, or memory utilization.

Example 15 includes one or more later or earlier examples, wherein the interrupts indicate receipt of packets by the network interface device.

Example 16 includes one or more later or earlier examples, wherein the interrupt handling is to perform processing of interrupts triggered by receipt of packets by the network interface device.

Example 17 includes one or more later or earlier examples, and includes a method comprising: based on a first level of load at a first domain, directing interrupts for handling by a processor in the first domain and based on a second level of load at the first domain, direct interrupts for handling by a processor in a second domain, wherein: the first domain comprises a first Non-Uniform Memory Access (NUMA) domain, the second domain comprises a second NUMA domain, and a memory access from the second domain to the first domain has a higher latency than a memory access from the first domain to the first domain.

Example 18 includes one or more later or earlier examples, wherein the load is based on one or more of: interrupt queue depth, packet receipt timestamps, intervals between interrupts, core utilization, or memory utilization.

Example 19 includes one or more later or earlier examples, wherein the interrupts indicate receipt of packets by a network interface device and wherein the interrupt handling is to perform processing of interrupts triggered by receipt of packets by a network interface device.

Example 20 includes one or more later or earlier examples, and includes assigning an application thread to process packets to a domain that performs interrupt handling.

1. A network interface controller, comprising
a host interface;
a network interface; and
circuitry to:
monitor packet processing load across multiple Non-Uniform Memory Access (NUMA) domains, wherein individual ones of the NUMA domains comprising at least one processor and having a range of latency to access memory and different ones of the multiple NUMA domains have different ranges of latency; and
predictively migrate interrupt request handling from one of the multiple NUMA domains to another of the multiple NUMA domains.

2. The controller of claim 1, wherein the circuitry to monitor comprises circuitry to monitor at least one of interrupt backlog, queue depth, packet receipt timestamp intervals, per-core utilization, or memory utilization.

3. The controller of claim 1, wherein the circuitry is to allocate interrupt request handling in one of the multiple NUMA domains associated with the network interface controller by default.

4. The controller of claim 3, wherein the circuitry is to predictively migrate interrupt request handling from one of the multiple NUMA domains to another of the multiple NUMA domains based on load of the one of the multiple NUMA domains.

5. The controller of claim 1, wherein:
the circuitry is to predictively migrate interrupt request handling from one of the multiple NUMA domains to another of the multiple NUMA domains based on load of the one of the multiple NUMA domains and
the load is based on one or more of: interrupt queue depth, packet receipt timestamps, intervals between interrupts, core utilization, or memory utilization.

6. The controller of claim 1, wherein the interrupts indicate receipt of packets by the network interface controller.

7. The controller of claim 1, wherein the interrupt handling is to perform processing of interrupts triggered by receipt of packets by a network interface device.

8. The controller of claim 1, comprising circuitry to assign an application thread to process packets to a NUMA domain that performs interrupt handling.

9. The controller of claim 1, wherein the circuitry is to:
migrate performance of interrupt handling back to the one of the multiple NUMA domains from the another of the multiple NUMA domains.

10. At least one non-transitory computer-readable medium comprising instructions stored thereon, that if executed by one or more processors, cause the one or more processors to:
configure a network interface device to:
indicate a capability to determine a Non-Uniform Memory Access (NUMA) node to process interrupts and
based on a request to perform the capability, enable the capability in the network interface device to perform:
monitor packet processing load across multiple Non-Uniform Memory Access (NUMA) domains, wherein individual ones of the NUMA domains comprising at least one processor and having a range of latency to access memory and different ones of the multiple NUMA domains have different ranges of latency; and
predictively migrate interrupt request handling from one of the multiple NUMA domains to another of the multiple NUMA domains.

11. The computer-readable medium of claim 10, wherein the packet processing load is based at least on one of: interrupt backlog, queue depth, packet receipt timestamp intervals, per-core utilization, or memory utilization.

12. The computer-readable medium of claim 10, wherein:
based on a request to perform the capability, enable the capability in the network interface device to allocate interrupt request handling in one of the multiple NUMA domains associated with the network interface device by default.

13. The computer-readable medium of claim 12, wherein the network interface device is to predictively migrate interrupt request handling from one of the multiple NUMA domains to another of the multiple NUMA domains based on load of the one of the multiple NUMA domains.

14. The computer-readable medium of claim 10, wherein:
based on a request to perform the capability:
the network interface device is to predictively migrate interrupt request handling from one of the multiple NUMA domains to another of the multiple NUMA domains based on load of the one of the multiple NUMA domains and
the load is based on one or more of: interrupt queue depth, packet receipt timestamps, intervals between interrupts, core utilization, or memory utilization.

15. The computer-readable medium of claim 10, wherein the interrupts indicate receipt of packets by the network interface device.

16. The computer-readable medium of claim 10, wherein the interrupt handling is to perform processing of interrupts triggered by receipt of packets by the network interface device.

17. A method comprising:
based on a first level of load at a first domain, directing interrupts for handling by a processor in the first domain and
based on a second level of load at the first domain, direct interrupts for handling by a processor in a second domain, wherein:
the first domain comprises a first Non-Uniform Memory Access (NUMA) domain,
the second domain comprises a second NUMA domain, and
a memory access from the second domain to the first domain has a higher latency than a memory access from the first domain to the first domain.

18. The method of claim 17, wherein the load is based on one or more of: interrupt queue depth, packet receipt timestamps, intervals between interrupts, core utilization, or memory utilization.

19. The method of claim 18, wherein the interrupts indicate receipt of packets by a network interface device and wherein the interrupt handling is to perform processing of interrupts triggered by receipt of packets by a network interface device.

20. The method of claim 17, comprising:
assigning an application thread to process packets to a domain that performs interrupt handling.
